(19) United States
(12) Patent Application Publication
(10) Pub. No.: US 2004/0054968 A1
(43) Pub. Date: Mar. 18, 2004

(54) Web page with system for displaying miniature visual representations of search engine results

(76) Inventor: Daniel Savage, San Jose, CA (US)

Correspondence Address: DANIEL SAVAGE, 2807 Westgate Ave, San Jose, CA, 95125, US

(21) Appl. No.: 10/189,320

(22) Filed: Jul. 2, 2002

Related U.S. Application Data
(60) Provisional application No. 60/302,555, filed on Jul. 3, 2001.

(51) Int. Cl. G06F 15/00

(52) U.S. Cl. 715/513

(57) ABSTRACT

A web page with a system for displaying search engine results as multiple small versions of the actual web sites found during the search. The system can retrieve HTML source code from different domains, alter the code so it can be displayed at a smaller size, and then display the smaller web pages on a single web page. The system is comprised of a plug-in based application with a function for retrieving a list of search results, retrieving the URL source code across domains for each result, a function for altering the size parameters of source code elements, and a function for displaying the altered source code so that many pages can be displayed on the same page. In the preferred embodiment, the system includes a magnifying glass tool that allow the user to enlarge small portions of each miniature web page so the miniaturized content can be read at full size.

### BACKGROUND

1. Field of Invention

The present application relates generally to use of the internet, and more particularly to methods for displaying search engine results to include miniature visual representations of each web page found, and for viewing a multitude of web pages in the same window

2. Description of Prior Art

The world wide web is a visual medium composed of more than merely text. It now contains, photos, drawings, movies, applets, sounds, etc. Yet, all search engines to date display the results of a web search as text only descriptions making it nearly impossible to tell a professionally developed site from a poorly constructed site. A text only description cannot provide a complete representation of the multimedia content on a web site.

Currently there are two methods for a searcher to see what a web site really looks like. One is to click on the text description link provided by the search engine replacing the search results with the web page. If the site is not relevant, the searcher must click the back button on the browser to reload the search results. The other method is to open a new window from the link, obscuring the search results with a new window. If the web site is not relevant the operator must closing the window in front of the search results, or push it to the side of the desktop. Much time is wasted in this back and forth manner necessary to “see” what the web pages actually look like.

Ideally it would be great to “see” all the web pages found in a search result, but web browsers simply were not designed to view more than one web page at a time in the same workspace. Web browsers merely read lock-step the web page markup language and display it. Web browsers lack the ability to alter the display of the web page's markup language.

The problem of viewing multiple web pages manifests itself not only during web searches, but whenever the user would like to see content from more than one web page at a time. The only method available for viewing content from more than one web page at a time is to open more than one web browser window, and with much manipulation resize the windows to make them each cover a portion of the desktop workspace, but in doing so, the operator can only view a portion of the content from each browser window.

Invention U.S. Pat. No. 5,835,092 to Boudreau (1998) describes methods to deal with this problem by allowing the user to select portions of other web pages and display them automatically on another system. Unfortunately the result of such a system would be a confusing collage of web page content that is difficult to comprehend because it is taken out of it's original display and context. In addition these methods lock the user into viewing only that portion of the content. In order to view more of the content from a web page source, the user must go back to the source once again obscuring the web page containing the content.

Invention U.S. Pat. No. 6,122,657 Hoffman, Jr (2000) describes the ability to alter the display of web pages for filtering out content as it is requested from the server. Such a mechanism could not be used to alter the sizes of web pages because the mechanism would be fraught with errors. When the source code is loaded it reserves browser space for the sizes of the content. If the request for the content is altered by the filter then it may not match the browser space reserved for displaying the content. The result of each mismatch will be a formatting error that will change the look of the web page. For instance if a picture is removed, it will change the way the text flows around the picture, or if text is removed it will change the way the pictures are displayed on the page. Formatting errors will result in a web page that may look nothing like the original. In addition this filtering mechanism must exist as an added platform specific program such as a dII or plug-in that is not included with the browser thus requiring the user to download and install the application into the browser before using the filter.

Another invention U.S. Pat. No. 5,903,904 Peairs (1999) describes a method for making iconic representations of documents in a database. This invention could be used to make iconic representations of web documents, but it would not solve the problem of viewing multiple web pages because the invention removes the content in order to make the icon. Besides which, creating icons for the entire web would require an enormous amount of time and equipment. In addition, the time it takes to display the original web page and then to calculate, draw and format pictures to make an icon would be time consuming if done dynamically.

A system could be also be designed to index the web and take screenshots of every web page, then shrink them to a manageable size so that multiple miniaturized screenshots could be shown in the same workspace, but there would be several problems associated with such a system. Indexing and imaging the entire web would take several months and require an enormous amount of hardware and software to retrieve, process, and store the images. In addition, by the time the content images were finished many of them would be months out of date.

Other inventions such as U.S. Pat. No. 6,226,642 Beranek (2001) describe entire systems such as web appliances or entire new browsers that could be built to reformat web pages. These systems still do not solve the problem of viewing content from multiple pages at the same time, and also require that the user purchase, install, or download an entire new system, an entire new browser, or a web-appliance just for viewing the altered content.

Another method for solving the multiple web page display problem would be to load the web page in the background, then take a screen-shot and then display it on the client's computer. This method would require access to platform and operating system functions which browsers currently do not have. To access these functions the software would have to be rewritten and downloaded to every client computer before it could run. In addition the time it takes to display the web page and then take a picture of it, store the picture, and then redisplay it again as an image is extensive. Most of the time lag would be occur because the original images and multimedia content have to load from the server before the screen-shot can be taken, shrunk, and redisplayed.

Another method for solving the multiple web page display problem would be to use a server side CGI script to alter the source code and resize the display parameters and then send it back to the client. A problem with this method is that it requires the server to process the web pages. The processing ability of a server would be quickly overwhelmed by multiple requests from different clients and would turn the server into a bottleneck. To avoid the bottleneck, a large amount of computer servers would have to be available to process the requests. In addition the time it takes to send, process, and resend the code could never be as fast as processing on the client side.

A client based system that would alter source code from other web sites and redisplay them would be would be quickest and most dynamic, but it is important to note that a client based web processor system could not be built using JAVA applets or JAVASCRIPT. These languages have security measures built in that prevent the accessing of web content across URL domains. e.g. if I am at www.yahoo.com and want to get and alter the source code from www.netscape.com it is considered a security violation and is prohibited by the language itself.

There are other ways to tackle the problem of viewing more than one web page at a time. A new browser could be designed that includes functions necessary for imaging and shrinking web pages using their source code, but once again it would require a user to download and install a new browser instead of their current browsing system. Installing a new browser is no trivial task. Upon installation, the operators will lose their bookmarks, and have to download new plug-ins that they previously collected for viewing specialized multimedia content. Most users feel uncomfortable downloading and installing new systems on their computers because the risk is often simply not worth the reward of the new function.

### SUMMARY

In accordance with the present invention a web page with a system for displaying miniature visual representations of search engine results comprising a search engine result list retriever, a URL source code retriever, a source code markup language altering system which will create miniaturized versions of the web pages, and a browser display system for displaying the miniaturized web pages so that a searcher can see what the web pages actually look like rather than merely the usual textual descriptions.

Objects and Advantages

Accordingly several objects and advantages of my invention are:

to provide visual representations instead of merely textual representations of web pages during web searches so that users can see the entire multimedia representation of the web page and it's content.

to provide search engine results that include smaller fully functional versions of actual web pages so that users can “see” the web page as well as read a description of the web page.

to provide a system which can display multiple miniature versions of web pages found in a search on the same workspace allowing the user to see all the web pages at the same time in the same space saving time and tedium by eliminating the behavior of clicking on a search result to see the web page, looking at the web page to see if it's what's desired, then clicking the back button on the browser to see the search results again.

to provide a client based web page system that will allow the viewing of multiple web pages in the same workspace by retrieving web page source code across web domains and altering and processing the web page source code so that it will display smaller whereby users can see multiple web pages in the same workspace.

to provide a web page that allows the user to view content from multiple web pages at the same time without having to cut up the content and display in a collage format in a separate window.

to provide a web page that can alter the source code of other web pages before it is displayed without formatting errors that would be caused by a mechanism that filters out calls from the browser to the server for content.

to provide a web page that can create fully functional smaller versions of entire web pages that fit in the same workspace eliminating the problems that browsers have displaying more than one web page in the same workspace

to provide a web page which allows the user to view multiple web pages in the same workspace without having to obscure one web page to see another.

to provide a web page that can alter the display other web pages freeing the browser to display web pages differently rather than lockstep by the markup code.

to provide a web page that can shrink and display several other web pages in the same workspace increasing browsing productivity and eliminating the necessity of the back and forth web page browsing.

to provide a web page that can display multiple, fully functional, smaller versions of existing web pages rather than abstracting the pages into meaningless icons devoid of content.

to provide a system that uses a web page's source code and browser functions to generate a visual representation of the web page rather than the time consuming operating system dependent step of waiting for a web page to load and then taking a screen shot of the page.

to provide a web page that creates and displays smaller versions of other web pages by using the client's computer to process and create the smaller versions without using the time consuming method of taking screen shots of the web pages.

to provide a system that can in a matter of seconds display a current visual representation of any web page rather than generating visual representations of every web page in advance and storing them on a server where are they soon outdated.

to provide a system on the client's computer that can generate dynamically small visual representations of any web page so that a network of servers for generating and storing the visual representations of web pages is unnecessary.

to provide a system for altering the source code of web pages that does not require the purchase and installation of a web appliance.

to provide a system for altering the source code of web pages that does not require the purchase and installation of a new browser causing the user to lose their bookmarks and have to reinstall additional plug-ins and preferences accumulated during normal browser use.

to provide a system on a web page that solves the problem of accessing and altering web page source code at different URL domains which is prohibited by JAVASCRIPT or JAVA.

to provide a web page that allows the user to see multiple web pages in the same workspace which uses plug-ins that are included with the browser eliminating the need to download and install new plug-ins or resources.

to provide a web page altering system that dynamically processes web pages on the client computer rather than using CGI routines on the server computer so that the server computer is not overwhelmed by multiple processing requests.

to provide a web page altering system that processes web pages on the client's computer rather than more time consuming method of sending data to the server for CGI processing and then sending it back to the client for display.

to provide a system that is capable of altering a web page's source code to eliminate advertisements thus creating a faster and less intrusive web browsing experience without the use of web appliances, winsock filters, extra plug-ins or downloads.

to provide a system that allows miniature versions of web pages to be viewed in the same workspace that includes a magnifying glass tool which can be used to enlarge portions of the miniaturized web pages for actual size viewing.

Further objects and advantages of my invention will become apparent from a consideration of the drawings and ensuing description.

### DRAWING FIGURES

FIG. 1 shows a web page

FIG. 2 shows a program flow chart

### REFERENCE NUMERALS IN DRAWINGS

10 frame containing html that embeds shockwave application, and a browser script

12 shockwave application

14 Shockwave Application Search Input Field

16 Shockwave Application URL Input Field

18 frame with browser script for magnifying tool

20 Magnifying Tool

22 frame for loading actual size web page sent from magnifying tool

26 Shockwave Application Search Engine Query Routine

30 Shockwave Application Source Code Retriever

32 Shockwave Application Source Code Changer

34 Shockwave Application Source Code Sender

36 Browser Script Source Code Receiver

38 Browser Script Source Code Displayer

40 Magnifying Tool Event Processor Routine

50-64 Extra Frames for additional URL miniature web page display

CD-ROM Listing

To implement the listing on the CD-ROM to build the invention, follow these instructions: The listing can run directly from the CD or from the web on a Macintosh or Pentium Class computer. The Macintosh computer should include system 8.6 with Netscape Communicator 4.7. A Pentium class computer should include windows 2000 and Explorer 5.5. The computer must be connected to the internet. To run the listing from the CD-ROM the file frameset.html needs to be opened with the browser. To run the listing from the web each file needs to be placed in the same directory of a web server. To start the program the user needs to open up a browser and enter the URL that points to frameset.html such as www.domain.com/directory/frameset.html. The CD-ROM listing will only work for simple sites. Future embodiments will work for more complicated sites.

File Descriptions

Frameset.html

HTML code containing a frameset that specifies the system layout

Control2.html

Web Page that contains the shockwave applet Minibrowser.dcr and a Browser Script

Minibrowser.dcr:Shockwave Applet to be embedded in Control2.html

1.html

Frame where miniaturized version of first URL web page will be displayed along with Magnifying Glass Tool

LeftRight.html

Frameset to hold frames 2-5

UpDown.html

Frameset to hold frames 6-10

2.html-8.html

Additional frames for the display of other URL's

Main.html

Loads and Displays actual size URL web page when called from the Magnifying Glass Tool.

MagnifyingGlass.gif An image of a magnifying glass.

Description/Operation

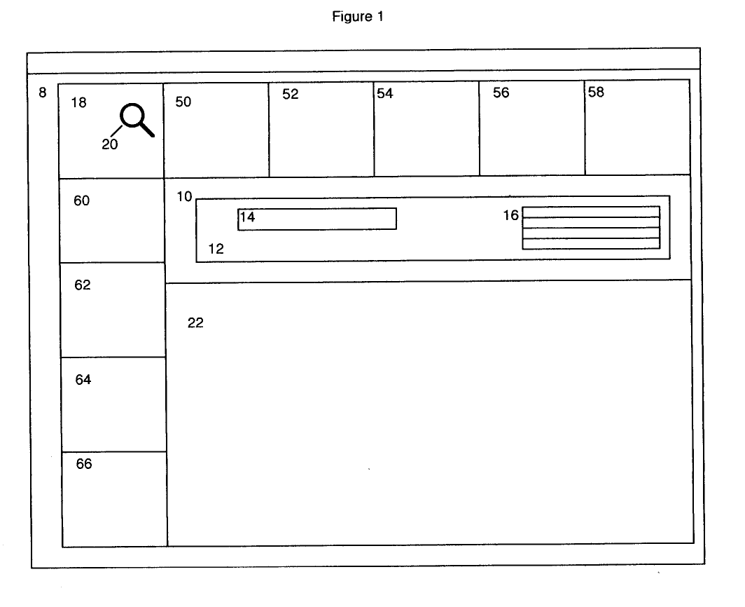

A representative embodiment of the web page of the present invention is illustrated in FIG. 1. The web page is composed of several frames 10, 12, 14, 18, 14, 16, 22 in a frameset 8. Frame 10 contains HTML that codes for the embedding of an application that uses the Shockwave plug-in, a plug-in included with all new browsers (Shockwave is a trademark of Macromedia). Frame 10 also contains a browser script written in Javascript that allows communication with the Shockwave application.

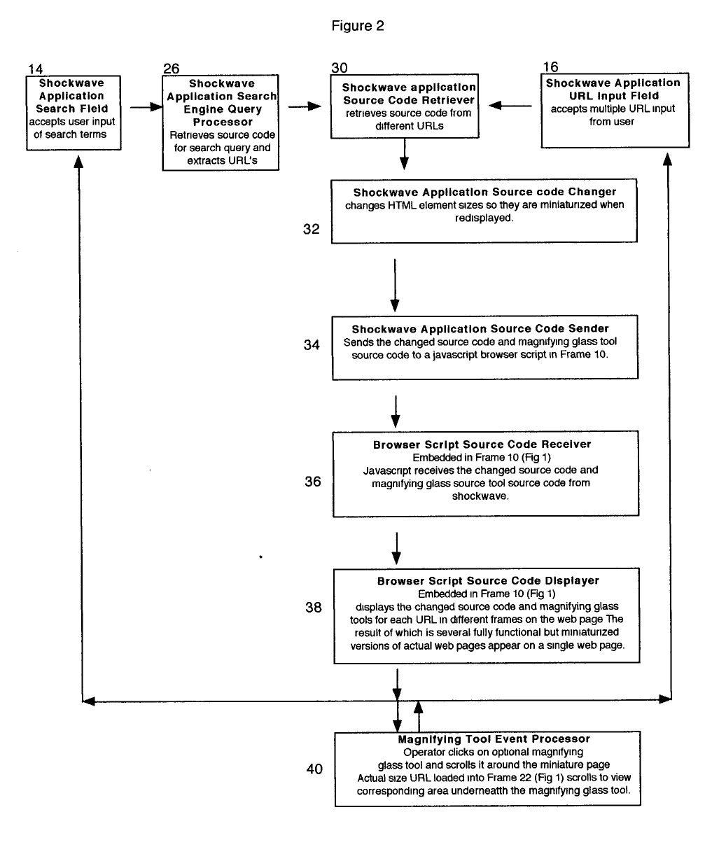

The Shockwave Application has two input fields: Search Input Field 14 and URL Input Field 16. The operator can input search terms into 14 and press the Enter key on the keyboard initiating the Shockwave Application to send the search term to a search engine such as Yahoo. The Shockwave Application then retrieves the Yahoo search result's URL page and extracts the URL's, placing them in the input field. Upon placing the URL's in the input field, the Shockwave Application initiates processing step 30 (FIG. 2). Note: If Yahoo changes their search result formatting, which they do quite often, then the program will have to be updated to correctly extract the URL's. If the formatting has changed, the system will not return any results until it is updated.

The user can also enter his/her own URL's into the URL Input Field making sure to type the “http://” before and “,,new” after the URL. For example: http://www.flipaloft.com,,new. Upon entering a URL in the URL Input Field and pressing the Enter Key on they keyboard, the Shockwave Application will also initiate processing step 30 (FIG. 2).

Processing step 30 retrieves the source for the URL. Once the source code is received processing step 32 (FIG. 2) changes HTML element sizes so they will be miniaturized when redisplayed.

Note: the listing on the CD-ROM will only process very simple web pages without Redirects, Frames, or Cascading Style sheets. The processing of Redirects, Frames, and Cascading Style Sheets will be included in future embodiments.

Processing step 34 (FIG. 2) of the shockwave application sends the changed source code and magnifying glass tool source code to be received by the Browser Source Code Receiver 36 (FIG. 2) contained in the browser script of frame 10 (FIG. 1). The Browser Script Source Code Displayer 38 (FIG. 2) embedded in Frame 10 (FIG. 1 ) then displays the changed source code and magnifying tool by rewriting the source code of one of the different frames on the web page such as Frame 18. The result of which is several fully functional but miniaturized versions of actual web pages are displayed in different frames of the frameset.

If the user clicks or drags the Magnifying Glass Tool 20 (FIG. 1 ) over different portions of the miniaturized web page then processing step 40 (FIG. 2) is initiated causing the actual size URL web page to load and scroll accordingly in Frame 22 so it can be visualized in actual size. URL's from other lines of URL input Field 16 (FIG. 1) will be placed in other available Extra Frames 50-64 (FIG. 1)

While my above description contains many specificities, these should not be construed as limitations on the scope of the inventions, but rather as an exemplification of one preferred embodiment thereof. Many other variations are possible.

### CONCLUSION, RAMIFICATIONS, AND SCOPE

Thus the reader will see that the web page of my invention solves the problem of displaying search engine results as actual miniaturized web pages rather than merely textual descriptions. My invention solves the problem by using merely a browser script and the included Shockwave Plug-in. Together these tools can also alter the size and content of web pages to solve the problem of viewing multiple web pages in the same workspace. Accordingly the scope of the invention should be determined not by the embodiments illustrated, but by the appended claims and their legal equivalents.

From the description above, a number of advantages of my web page should become evident. Web searchers will be finally able to see full multimedia representations of the web pages found in a search engine result rather than merely text representations as is the current state of the art. The web pages will be miniaturized versions of the actual web pages. This is all accomplished without the downloading of any additional software. Processing is done on the client machine and does not require extensive servers or equipment to process the web pages.

In addition, users can also load up their 10 favorite pages into the web page to view them simultaneously in the same workspace. Operators can also use a magnifying glass tool to view in full size any miniaturized portion of any of the miniaturized web pages.

I claim:

1. A web page with a system for displaying miniature visual representations of search engine results comprising:
a URL list retrieval system with means for downloading a URL list from a search engine result
a source code retrieval system web browser plug-in based application with means for downloading each URL's web page source code obtained by said URL list retrieval system.
a markup language altering system with means for changing markup language size parameters of said web page source code that a browser will display as a miniaturized miniaturized version of the original web page.
a browser display system with means for displaying a multitude of miniaturized web pages source code on a single web page's workspace
whereby multiple miniaturized versions of the original web pages found in the search engine result can be viewed in the same workspace allowing the operator to actually see the web pages rather than mere textual descriptions.

2. The web page of claim 1 wherein said web page is built using a combination of browser plug-in applications and browser scripts.

3. The web page of claim 7 wherein said web page is built using a combination of shockwave/flash and javascript

4. The browser display system of claim 1 further including means to display a magnifying glass tool which when scrolled over a miniature representation of a web page will display an enlarged portion of the miniature representation.

5. The markup language altering system of claim 1 further including means for deleting or rewriting portions of the markup language code

6. The web page of claim 1 further including means for allowing the user to enter their own list of URL's whereby content from several web pages can be viewed in a single workspace area.

7. A web page with a system for changing the display of a web page comprising:
a web page source code retrieving system with means for downloading web page source code across web domains
a markup language altering system with means for finding and changing markup language code of said web page source code so that the browser will display an altered version of the original web page
a browser display system with means for displaying said altered version
whereby web pages are altered so that a plurality of smaller versions of the original web pages can be displayed in the same workspace.

8. The web page of claim 7 further including means for obtaining a list of URL's from a search engine result to be changed

9. The web page of claim 7 further including means for allowing the user to enter their own list of URL's whereby content from several web pages can be viewed in a single workspace.

10. The web page of claim 7 wherein said web page is built using a combination of browser plug-in applications and browser scripts.

11. The web page of claim 7 wherein said web page is built using a combination of shockwave/flash and javascript

12. The browser display system of claim 7 further including means to display a magnifying glass tool which when scrolled over a miniature representation of a web page will display an enlarged portion of the miniature representation.

13. The markup language altering system of claim 7 wherein markup language parameters are rewritten or deleted.

14. The markup language altering system of claim 7 wherein markup language size parameters are altered.

15. A method for displaying multiple web pages in the same workspace comprising:
retrieving a list of URL's
downloading the source code from each said URL
changing said URL source code markup language to create an altered version of each web page
displaying altered web pages
whereby the system can retrieve the results of a web search, alter the source code for each URL found so that the search engine results can be user can actually see small versions of the web sites found during a web search on a single web page workspace.

16. The method of claim 15 wherein said list or URL's are obtained from a search engine result

17. The method of claim 15 wherein said changing alters markup language size parameters such that the source code will display a smaller version of the web page in the same workspace.

18. The method of claim 15 wherein said changing deletes or rewrites portions of the markup language

19. The method of claim 15 wherein said displaying allows multiple smaller versions of original web pages to be displayed in the same workspace.
